(19) United States
(12) Patent Application Publication
(10) Pub. No.: US 2009/0235859 A1
(43) Pub. Date: Sep. 24, 2009

(54) MULTI-PAGE BOOKMARKS & METHODS OF MANUFACTURING BOOKMARKS

(75) Inventors: ANNJEANETTE BAPTISTE, Warner Robins, GA (US); LORI RICE, Chico, CA (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: SMART SISTERS LLC, Chico, CA (US)

(21) Appl. No.: 12/406,669

(22) Filed: Mar. 18, 2009

Related U.S. Application Data
(60) Provisional application No. 61/037,488, filed on Mar. 18, 2008.

(51) Int. Cl. B42D 9/00

(52) U.S. Cl. 116/234

(57) ABSTRACT

Multi-page bookmarks and methods of manufacturing bookmarks are provided. A goal of the invention's embodiments is to provide an organized multiple page bookmarker in one convenient product. A multi-page integral bookmark can be useful for scholars, students, doctors, and book readers reading multiple pages in a single book, for example, religious texts, cookbooks, textbooks, reference books, and self-help books. In some embodiments, a bookmark is a multi-arm bookmark that can range in the quantities of arms per bookmark anywhere from 2 arms to 20 arms (arm numbers can be increased). The bookmark can be made to fit any length of book. At least one arm of a multiple arm set is a little longer than the others so that the user can always quickly identify their current or most important location in the book. For example, for a person reading a Bible, the longest arm (or a number of longer arms) could keep track of a current reading place, while the other arms may mark an important verse or story. In another example, a cook reading/using a cookbook, the longest arm could mark a main dish while other arms could keep track of side dishes, salads, desserts, and cocktails. A decorative bead, stone, and/or charm is provided on the top of the bookmark for holding the multiple arms together. Also, there are also decorative beads, stones, and/or charms on the bottom of each of the multiple arms to distinguish the various arms from each other. The bookmark arms are made from any natural and or synthetic fibers such as ribbon and/or hemp rope. Other embodiments are also claimed and described.

### CROSS REFERENCE TO RELATED APPLICATION & PRIORITY CLAIM

This patent application claims priority to and the benefit of U.S. Provisional Patent Application No. 61/037,488 filed 18 Mar. 2008, which is incorporated herein by reference in its entirety as if fully set forth below.

### TECHNICAL FIELD

The embodiments of the present invention relate generally to bookmarks and more specifically to multi-page bookmarks and methods of manufacturing bookmarks having multiple arms for use in easily and quickly accessing multiple page portions of a book.

### BACKGROUND

Bookmarks have been used for a long time to mark a place in a book. Often bookmarks are used to mark someone's reading location in a book so that a reader does not have to remember the page/position of a last reading point. In other uses, bookmarks are used to mark a specific location of interest. Conventional bookmarks, while serving their respective purposes, are designed only to mark a single position. As a result, current bookmarks can not mark multiple locations in a book. What is needed in the art, therefore, are multiple page bookmarks and methods for manufacturing multiple page bookmarks.

### SUMMARY OF EXEMPLARY EMBODIMENTS

The various embodiments of the present invention are multiple page bookmarks and methods for assembling multiple page bookmarks. According to some embodiments, a multi-page bookmark has multiple arms to mark different pages in a book. A multi-page bookmark could have anywhere between 2 and 20 arms, or any other number of arms as may be desired. In addition, a multi-page bookmark can be made to fit any length of book. For example, arms of the multi-page bookmark can include lengths ranging from a few inches to about thirty inches. According to some embodiments, a least one arm of a multi-page bookmark is a little longer than the other arms. This enables a user to always quickly identify a book position marked by a longer arm. In some embodiments, the arms are coded with objects having unique physical exterior effects that are positioned on the arms so that the arms can be distinguished from each other. Sample objects can include beads with various colors, shapes, and exterior surfaces.

Other aspects and features of embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF FIGURES

FIG. 1 illustrates a perspective view of a diagram of a multiple page bookmark having multiple arms in accordance with some embodiments of the present invention.

FIG. 2 illustrates a perspective view of a diagram of multiple page bookmark having multiple arms in accordance with some embodiments of the present invention.

FIG. 3 illustrates a perspective view of another exemplary multiple page bookmark embodiment having multiple arms in accordance with some embodiments of the present invention.

FIG. 4 illustrates a perspective view of another exemplary multiple page bookmark embodiment having multiple arms in accordance with some embodiments of the present invention.

FIG. 5 illustrates a perspective view of another exemplary multiple page bookmark embodiment having multiple arms in accordance with some embodiments of the present invention.

FIG. 6 illustrates a perspective view of another exemplary multiple page bookmark embodiment having multiple arms in accordance with some embodiments of the present invention.

### DETAILED DESCRIPTION OF PREFERRED & ALTERNATIVE EMBODIMENTS

Referring now to the figures, wherein like reference numerals represent like parts throughout the several views, exemplary embodiments of the present invention will be described in detail. Throughout this description, various components may be identified having specific values or parameters, however, these items are provided as exemplary embodiments. Indeed, the exemplary embodiments do not limit the various aspects and concepts of the present invention as many comparable parameters, sizes, ranges, and/or values may be implemented.

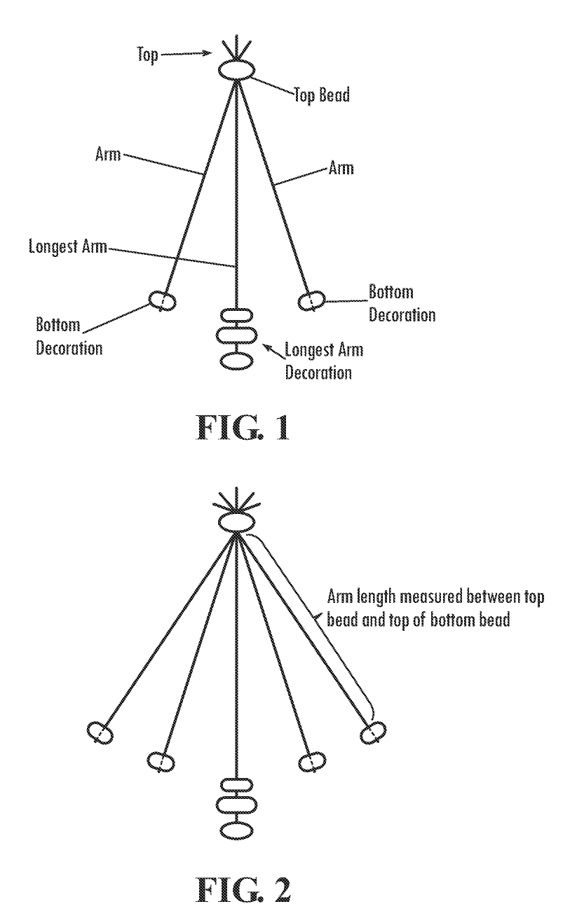

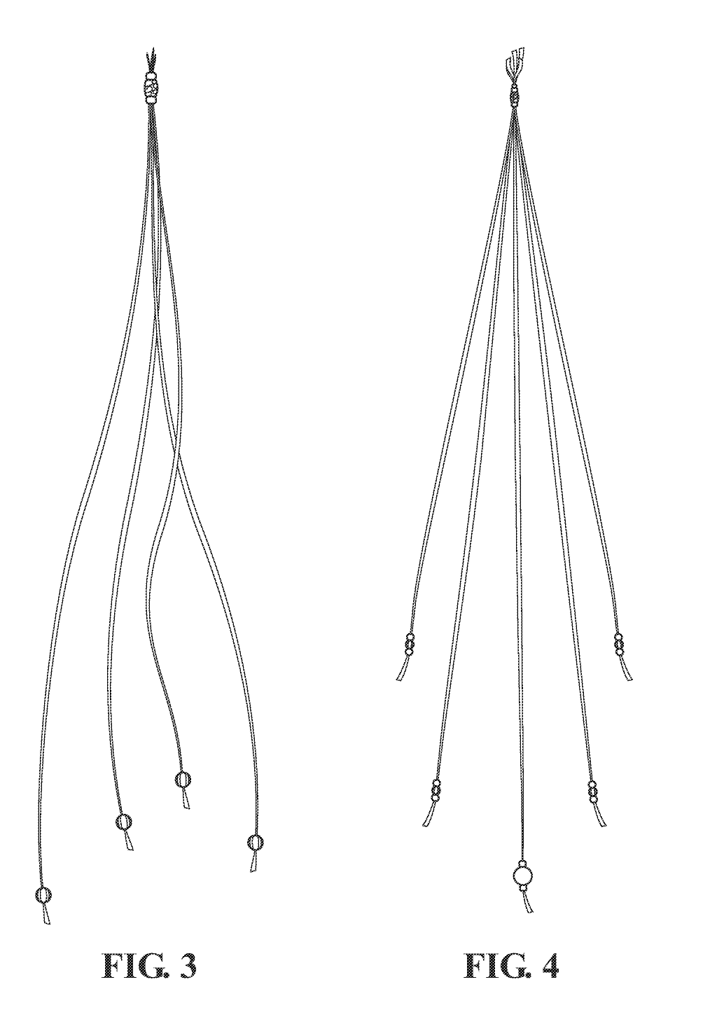

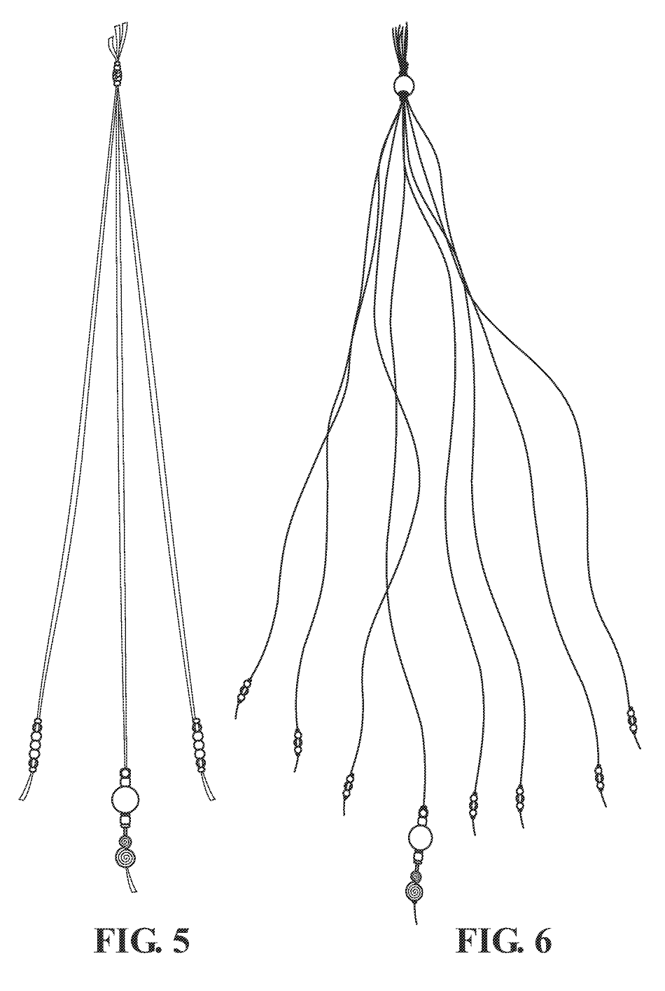

As shown in FIGS. 1-6, embodiments of the present invention are multi-page bookmarks. The multi-page bookmarks can be made with multiple arms. The arms can be made using ribbon, hemp, leather, silver, gold, chains, and/or other such thin, flexible materials. The arms may also be made with combinations of such materials or other materials as may be desired. The arm materials should be thin so as to not prevent pages of a book from closing on each other. Also, the multiple arms should be made of material capable of being easily bundled together, such as being tied together, to form an integral bookmark. Preferably, at least one of the arms is made longer than the other arms so that the arms can be distinguished from each other. In some embodiments, the arms can all have different lengths or be grouped in similar length sets. By utilizing arms having different lengths, the bookmark allows users to quickly access previously marked positions in a book.

As illustrated in FIGS. 1-6, a knot can be made on a top end of the multiple bookmark arms. An ornamental decoration, such as a large bead, stone, or charm can be positioned near the knot to mark a top end of the bookmark. The ornamental decoration can be made of various products including glass, plastic, metal, metal alloys, material composites, organic materials, naturally occurring materials, inorganic materials, and the like. The longest arm (or longer arms) can be decorated with a number of decorations (e.g., beads, stones, and/or charms) to distinguish it from other arms. The remaining arms can be also decorated with such decorations (e.g., beads, stones, and/or charms). It is not important how the arms are decorated. Rather what is important, according to some embodiments, is to uniquely decorate the various arms so that a user can distinguish the arms from each other.

As shown in the attached figures and discussed below in the claims section, the ornamental decorations can be secured to the bookmark arms in various fashions. In some embodiments, the ornamental decorations are held in a substantial stationary position by knots on either side of the decoration. This may be done with ornamental decorations on each individual arm or an ornamental decoration for bundling all arms to connect the multiple arms together. Knots can be formed in the bookmark arms by tying the arms upon themselves so that arms have an increased diameter larger than apertures disposed within the ornamental decorations. In this manner, the ornamental decorations can be held at one or more desired stationary locations on the bookmark arms. In other embodiments, other fasteners (e.g., crimping beads) could be used to keep ornamental decorations stationary. Such other fasteners could include crimps, adhesives, or braiding/tying the arms on exterior surfaces of the ornamental features. Still yet other fasteners could enable users of a bookmark to adjust positioning of ornamental decorations along the length of the arms. Thus, the fasteners could include detent mechanisms or other such detachable affixing mechanisms enabling movement of the fasteners along an arm's length.

The multi-page bookmark is an all in one bookmark, allowing users to mark multiple pages in a single book, with a clean, organized and aesthetically pleasing presentation. For example, in some embodiments, a longest arm helps the user to immediately find a place of interest in the book. Other arms can be used to mark other important places in the book for quick reference, or important parts that a user desires quick access to. Still yet, one book mark can be used to mark multiple reading positions in a book so that multiple people can read the same book without using multiple book marks.

As also shown in FIGS. 1-6, the multiple arms are attached neatly in one convenient, aesthetic product. The longest arm (or longer arms) helps the user to immediately find their place in the book. The other arms can mark important places in a book for quick reference, or important parts that a user wants to easily access. Together the multiple arms can hold several places in a book for a user.

Bookmark embodiments of the present invention may also include other features. For example, the multi-page bookmark does not need to be fastened to a book's binding or cover. Also, it is simple in design as there are no adjustable parts to the multi-page bookmark. As another example, the bookmark does not interfere with reading when not in use, and it can be quickly and easily changed or removed. Also, the bookmark can be used in hardcover, soft-cover, spiral-bound or other binding type books or printings. The bookmark is also reusable and enables multiple people to read the same book due to uniquely coded arms and objects carried by the arms.

The embodiments of the present invention are not limited to the particular formulations, process steps, and materials disclosed herein as such formulations, process steps, and materials may vary somewhat. Moreover, the terminology employed herein is used for the purpose of describing exemplary embodiments only and the terminology is not intended to be limiting since the scope of the various embodiments of the present invention will be limited only by the appended claims and equivalents thereof. Thus, while embodiments of this invention have been described in detail with particular reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

We claim:

1. A multiple page bookmark comprising a plurality of book marking arms, the multiple page book mark comprising:
a plurality of elongated flexible arms each having a first end to be placed proximate a top end of a book and a second end to be placed proximate a bottom end of a book, at least one of the arms having a length greater than at least one of the other arms;
a coupling member comprising an aperture located within the coupling member such that the aperture defines an open passage through the coupling member, the open passage of the coupling member disposed around the first end of the arms such that the coupling member bundles the arms in a bundle within the open passage of the coupling member; and
a plurality of objects each defining an aperture through the objects such that an internal passageway is provided in each of the objects, at least one of the objects being positioned on at least one the arms proximate the second end of the arms.

2. The multiple page book mark of claim 1, wherein the objects placed on each of the arms has unique physical exterior effects to distinguish the arms from each other.

3. The multiple page book mark of claim 1, wherein the objects placed on each of the arms are coded with unique codings to distinguish the arms from each other.

4. The multiple page book mark of claim 1, wherein the at least one of the arms having a length greater than the other arms carries a plurality of beads different from one or more beads carried by the other arms to distinguish the longer arm from the other arms.

5. The multiple page book mark of claim 1, wherein the coupling member and each of the objects are spaced apart from each other at a length greater than a book such that the coupling member and the objects are spaced away from top and bottom edges of a book.

6. The multiple page book mark of claim 1, wherein the elongated flexible arms each comprise an arm portion that extends beyond the coupling member.

7. The multiple page book mark of claim 1, wherein at least two of the arms of the plurality of arms are coded with exactly the same objects carried on the two arms.

8. The multiple page book mark of claim 1, wherein the coupling member has an external shape selected from the group comprising spherical, ovoid, cube, conical, or a combination thereof.

9. The multiple page book mark of claim 1, wherein the plurality of arms comprise position stop mechanisms disposed on each side of the coupling member to substantially keep the coupling member stationary along the length of the plurality of arms.

10. The multiple page book mark of claim 1, wherein the plurality of arms each comprise knots disposed on each side of corresponding objects carried by the arms to substantially keep the objects stationary along the length of the plurality of arms.

11. The multiple page book mark of claim 1, wherein each of the objects comprise unique indicia displayed on an exterior surface of the objects to distinguish the objects from one another.

12. The multiple page book mark of claim 1, wherein each of the objects and arms comprise a unique color marking to distinguish the objects from each other and the arms from each other.

13. The multiple page book mark of claim 1, wherein each of the arms has a unique length such that the arms have an extension portion extending below a bottom book edge of a unique length.

14. The multiple page book mark of claim 1, wherein each of the arms are adapted to extend out from the coupling member and the bundle toward a book in a divergent fusion such that the arms can correspond to different pages of a book.

15. A multiple page bookmark comprising a plurality of book marking arms for marking a plurality of pages or places in a book, the multiple page book mark comprising:
at least one coupling member comprising an exterior surface and defining an interior passageway passing substantially through a central axis of the coupling member, the interior passageway defining apertures on opposing ends of the coupling member and defining an interior space within the at least one coupling member;
a plurality of marking arms each for marking at least one location in a book, the marking arms operatively configured to together carry the at least one coupling member such that the at least one coupling member fully envelops the plurality of marking arms in a bundle within the interior space of the at least one coupling member and such that the plurality of marking arms pass through the opposing apertures of the coupling member and are disposed within the passageway; and
at least one coded object carried by each of the plurality of marking arms at a position distal from the at least one coupling member wherein at least one of the coded objects carried by the plurality of marking arms comprises a unique coding relative to objects carried by the other arms.

16. The multiple page book mark of claim 15, wherein the at least one coded object carried by each of the plurality of marking arms comprises at least one of a bead, charm, alphanumeric tag, sea shell, chain, stud, pin, eyelet, rivet, punch, snap, jewel, and a nail head.

17. The multiple page book mark of claim 16, wherein one of the arms of the plurality of arms has a length greater than the other arms.

18. The multiple page book mark of claim 17, wherein at least one of the coupling member and coded object are disposed generally between stop movement elements to keep the coupling member and the coded object in a substantially stationary position.
